(19) United States
(12) Patent Application Publication
(10) Pub. No.: US 2008/0120975 A1
(43) Pub. Date: May 29, 2008

(54) Stirling Thermodynamic cycle rotary thermal machine

(76) Inventors: Jiri Frolik, Prahe (CZ); Bedrich Kutil, Kadan (CZ)

Correspondence Address: Peter R. Ruzek, 24 Green Woods Lane, Farmington, CT, 06085, US

(21) Appl. No.: 11/998,067

(22) Filed: Nov. 28, 2007

(30) Foreign Application Priority Data
Nov. 29, 2006 (CZ) PV 2006-749

(51) Int. Cl. F02G 1/043; F01B 29/00

(52) U.S. Cl. 60/525; 418/83

(57) ABSTRACT

A Stirling thermodynamic cycle rotary thermal machine includes an eccentric shaft rotatably supported in a stator housing, a plurality of double piston carriers each carrying a plurality of pairs of oppositely arranged pistons, and a rotor having a number of cylinders each accommodating one of the pistons. Hot and cold corridors, separated from one another by a thermally separating wall, are defined around the rotor. Some of the cylinders in the rotor are associated with the hot corridor and the remaining ones with the cold corridor in a heat-exchange relationship therewith. Conduits with regenerators interposed in them connect the hot and cold corridor pistons with one another such that the respective hot corridor cylinder is ahead of the associated cold corridor cylinder by 90° as considered in the direction of rotation of the rotor. A transmission with a transmission ratio of 1:2 is interposed between the eccentric shaft and the rotor so that the eccentric shaft always rotates at twice the speed of rotation of the rotor.

### BACKGROUND OF THE INVENTION

1. Technical Field

The invention relates to a rotary thermal machine operating on the principle of the Stirling thermodynamic cycle, with radially disposed reciprocating pistons supported on an eccentric central shaft, in which a hypocycloidal transmission with a transmission ratio of the revolutions of the eccentric central shaft and an entraining rotor being 2:1 is being used for the reciprocating movement of the pistons, utilizing the thermodynamics of the Stirling cycle, or possibly of the Ericson cycle, or even further similar thermodynamic cycles.

2. Description of Related Art

The heretofore known embodiments of Stirling motors are constructed in such a manner that the generally known thermodynamic cycle of the Stirling motor, based on the difference in temperatures in the environment of the hot and cold cylinder, is being used therein, with an interposed regenerator serving for the accumulation of the heat of the working gas leaving the hot cylinder and with an auxiliary cooler with an external circulation of the cooling medium removing excess heat from the environment of the cold cylinder, in which manner a thermal gradient is created that constitutes a prerequisite for the functioning of the Stirling thermodynamic cycle that is sufficiently described in the technical as well as the patent literature.

What was found to be problematical is that in none of the heretofore known concepts of the Stirling motor has a sufficiently rapid supply of heat into the hot cylinder and a sufficiently rapid removal of heat from the cold cylinder been satisfactorily solved in such a manner that it would be possible to regulate the instantaneous performance of the thermal machine with external heating operating on the basis of the Stirling thermodynamic cycle, which would be usable, for instance, directly for the propulsion of motor vehicles. The region of the cold end of the Stirling motor is not, in reality, cold because it is not possible to physically separate the hot and the cold portion of the gaseous working contents of a pair of cylinders that are connected with one another by a shared volume from each other. For this reason, it is not appropriate, for the exact definition of the temperature of the cold cylinder, to use the expression “cold cylinder”, but rather, more precisely, “cylinder with intermediate temperature”, because, at higher rate of exchange of the gaseous medium between the cold and hot cylinder, it is not possible to remove the excess heat from the vicinity of the cold cylinder at a sufficiently rapid pace. It is generally valid that the higher the rotational speed of the Stirling motor, the smaller is the difference between the temperatures of the hot and the cold ends of the Stirling motor, as a result of which decrease in its efficiency and its output occurs. More detailed information about this problem of Stirling motors is presented in the publication “Stirling and Vuilleumier Heat Pumps-Design and Applications”, published by McGraw-Hill, Inc. in 1990, ISBN 0-07053567-L.

A further problem encountered in the heretofore proposed Stirling motors is the implementation of the withdrawal of the torque. In standard Stirling motors, the torque is taken away via a rhombic or classical crank mechanism, each of which is very heavy, significantly increases the overall mass of the motor, and causes problems with the sealing of the working space against loss of pressure in the gaseous working medium, because the majority of Stirling motors works with elevated-pressure gaseous medium at the pressure of several bars all the way to about 25 Mpa (megapascals). The higher the working pressure, the higher is the output of the motor.

In more recently proposed implementations of Stirling motors, multi-piston concepts with a smaller or a small capacity of the individual cylinders predominate, the smaller gaseous medium charge of which renders an increase in the heating up and the exchange of the gas between the hot and the cold piston of the motor possible, which leads to an increase in the rotational speed and hence to a rise in the output of the machine. The number of additional rhombic mechanisms or of further sections of the crankshaft in the classic concepts of the Stirling motor, however, increases with each further built-in piston, which results in an increase in the mass of the equipment, so that the achievable decrease in the volumes of the working pistons is limited by the ultimate magnitude of their output. In the event that a rhombic mechanism is being used for the output of the torque from the machine, each of the pistons has to be provided with its own piston rod, crosshead, crosshead guide and its own rhombic mechanism, which disproportionately increases the weight of the machine in relation to its output. The same is also applicable when a classic crankshaft is being used in Stirling motors of the a type. Even for this reason, the conventional constructions of Stirling motors include at most two or four pistons with relatively large associated cylinder volumes.

Among other problems of multi-piston Stirling motors with classic constructions is the recognized fact that, with the increasing number of the cylinders, it is necessary to increase the number of the heating and cooling surfaces as well, which leads to complicated constructions and, at the same time, to an increase in the consumption of fuel and to an increase in the circulation amount of the cooling medium at the cold cylinder side. Also, the volume occupied by the machine increases disproportionately in relation to its output.

Multi-piston constructions of the Stirling motor are described, for instance, in the Letters Patent DE 24 02 289, DE 37 09 266 and U.S. Pat. No. 4,676,067. In the Letters Patent DE 24 02 289, the complexity of the multi-piston thermal machine is evident, as well as the multitude of the structural parts, which disproportionately increases the mass of the equipment as a whole and also increases the overall space occupied by the same.

The Letters Patent DE 37 09 266 addresses the control of the output of a given multi-piston Stirling motor by the use of a linear electric generator, wherein individual magnets are secured on the crosshead of the individual piston rods of the associated pistons. The electric current generated in this manner can be easily controlled in accordance with the instant need, for instance for the propulsion of motor vehicles. Once more, the problem of this solution is the excessive increase in the overall mass of the equipment.

U.S. Pat. No. 4,676,067 discloses a solution of a multi-piston thermal machine operating on the basis of the Ericson thermodynamic cycle, which is supposed, in theory, to achieve maximum thermal efficiency. It is not known if this thermal machine was ever implemented because it is technologically difficult to produce one-way transfer valves operating at high temperatures. A large number of cylinders and a bulky crankshaft once more result in significant increase in the mass of this machine.

What is currently believed to be a solution that is closest to the present invention is described in the patent document U.S. Pat. No. 1,460,382, in which a multi-piston Stirling thermal machine is described that includes a considerable number of cylinders with smaller volumes, wherein cooperating pairs of cylinders of the cold part of the machine and of the hot part of the machine are interconnected by connecting channels via heat regenerators, and the torque output is transmitted through a hydraulic motor. A drawback of this solution is that the output of the mechanical work in this machine, being transmitted through the intermediary of the hydraulic motor, results in a complicated withdrawal of the translational forces from the opposite end of the working pistons, where, for instance, a considerable danger of penetration of oil into the working piston arises, and conversion of mechanical energy into pressure energy of an oil column is not being addressed. The structure of this machine as such exhibits a multitude of heating and cooling sites corresponding to the number of cylinders, which results in increased energy consumption and in a complicated construction of this machine.

General conclusions from these examples indicate that those multi-piston thermal machines in stationary implementations as serial piston motors exhibit, in comparison with customary petrol engines, excessive mass and a considerably increased occupied space. This, together with difficult control of the change in the output of thermal machines operating on the basis on the Stirling thermodynamic cycle, results in problems when attempting to utilize them in road traffic applications.

### SUMMARY OF THE INVENTION

It is, therefore, an object of the present invention to avoid the disadvantages of the prior art.

More particularly, it is an object of the present invention to create a thermal machine of the kind that would eliminate the drawbacks mentioned above and that would achieve such dimensional and output parameters as to make the use of the Stirling thermodynamic cycle possible on a wider scale than heretofore.

Still another object of the present invention is to so to construct the machine of the present invention as to be useable not only for converting thermal energy into kinetic energy, but also, with appropriate modifications, as an efficient cooler, thermal pump, co-generation unit and in further possible applications.

In pursuance of these objects and others that will become apparent hereafter, one feature of the present invention resides in a rotary thermal machine operating on the principle of the Stirling thermodynamic cycle, which includes a stator housing surrounding an internal space; an eccentric shaft mounted on the stator housing for rotation about a main axis extending across the internal space of the stator housing and including a plurality of circumferentially equidistantly spaced eccentric portions centered on respective eccentric axes parallel with the main axis; a plurality of substantially radially extending double piston carriers each mounted on at least one the eccentric portions of said eccentric shaft for movement with the respective eccentric portion about the main axis but with freedom of angular movement about the eccentric axis; a predetermined number of pistons immovably supported on the double piston carriers and extending substantially radially outwardly therefrom in opposite directions; a rotor mounted in the internal space for rotation in a predetermined direction about the main axis in including at least one cylinder carrier having the predetermined number of cylinders therein, each for accommodating one of the pistons; means for defining at least one cold corridor and at least one hot corridor around the rotor, some of the cylinders being associated with the cold corridor and the remaining ones being associated with the hot corridor, such defining means including at least one thermal separator wall separating the at least one cold corridor from the at least one hot corridor; individual conduit means each connecting one of the cylinders associated with the cold corridor through the thermal separator wall with a corresponding one of the cylinders associated with the hot corridor that is spaced ahead thereof by an angular distance of 90° as considered in the direction of rotation of said rotor; and a transmission interposed between the eccentric shaft and the rotor and having an overall transmission ratio of 1:2 so that the eccentric shaft rotates at twice the predetermined speed of rotation of the rotor at all times.

It is advantageous each of said individual conduit means includes a heat regenerator, and respective hot and cold corridor conduits connecting the heat regenerator with the hot and cold corridor cylinders, respectively. Advantageously, each of the regenerators is situated within the at least one thermal separator wall. It is particularly advantageous when the at least one thermal separator wall includes a plurality of individual segments each including one of the regenerators and all complementing each other in the circumferential direction of the rotor into the separator wall.

To advantage, an output torque gear is mounted on one end portion of the eccentric shaft that extends to the exterior of the stator housing for joint rotation therewith

In accordance with another advantageous aspect of the present invention, the transmission includes an auxiliary shaft mounted on the stator housing for rotation about an auxiliary axis parallel to and spaced from the main axis; a first pair of meshing gears mounted on corresponding portions of the eccentric and auxiliary shafts, and a second pair of meshing gears one of which is connected with the auxiliary shaft while the other is connected with the rotor for joint rotation therewith. Advantageously, the first pair of meshing gears has a transmission ratio of 1:2 and the second pair of meshing gears a transmission ratio of 1:1.

It is further advantageous when the rotor includes a plurality of segments each containing at least one of the cylinders associated with the cold corridor and one of the cylinders associated with the hot corridor.

The double piston carrier with the pistons mounted thereon, the eccentric portions of the eccentric shaft carrying the respective double piston carrier, respective portions of the rotor containing said cylinders, and the conduit means together form a unit; then, it is especially advantageous when the machine further includes a predetermined number of additional such units similar to the aforementioned unit and equidistantly angularly displaced about the main axis relative thereto and to one another.

The rotary thermal machine of the present invention advantageously further includes a sealing system at each end of said eccentric shaft, each such sealing system including a friction ring and a pressure spring acting thereon.

The stator housing advantageously has respective inlets and outlets communicating with said hot and cold corridors, respectively; and the machine includes at least one source of a cooling fluid for introducing the cooling fluid through a respective one of the inlets into the cold corridor for flow therethrough to an associated one of the outlets, and at least one source of a heating fluid for introducing the heating fluid through another one of the inlets into the cold corridor for flow therethrough to a different associated one of the outlets. Then, it is advantageous when the respective inlet, the at least one cooling fluid source, the cold corridor itself, and the associated outlet from the cold corridor are arranged and configured in such a manner that the cooling fluid flows through the cold corridor in a direction opposite to the direction of rotation of the rotor, and when the other inlet, the at least one heating fluid source, the hot corridor itself, and the different associated outlet from the hot corridor are arranged and configured in such a manner that the heating fluid flows through the hot corridor in a direction opposite to said direction of rotation of the rotor.

Particular advantages of the rotary thermal machine according to the invention reside, above all, in that, it is possible in this implementation of the machine to achieve a rapid exchange of heat between the hot and the cold cylinders owing to the significant decrease in their volume and in a reduction in the heating and cooling space, in each instance, into one shared hot or cold corridor that is being heated or cooled from only a single source of heat or a single source of coldness for all of the pairs of cylinders. The rapid heat exchange is further augmented by the rotary movement of the heat-exchange surfaces in the respective corridors opposite to the direction of flow of the working media. This rapid exchange of heat via the rotating heat exchange surfaces renders rapid regulation of the output of the machine possible. The reduction in the volume of the individual pairs of cylinders is compensated for by their multitudinousness. The machine exhibits compactness and small occupied space on the basis of the utilization of a hypocycloidal transmission which eliminates complicated mechanisms for the withdrawal of the torque that are customarily being used in the standard machines of this category.

### BRIEF DESCRIPTION OF THE DRAWING

The above features and others will become apparent from the accompanying drawing in which:

FIG. 1 is an axial sectional view of the machine of the present invention taken on line C-C of FIG. 2 and showing the internal arrangement of the rotary parts of the machine and their support in the stator housing, inclusive of the hypercycloidal transmission between the eccentric shaft and the rotary part;

FIG. 2 is a cross-sectional view taken on line A-A of FIG. 1 through a cold corridor of the machine inclusive of its inlet part with an independent source of the cooling medium;

FIG. 3 is represents a cross-sectional view taken on line B-B of FIG. 1 through a hot corridor of the machine, inclusive of an independent source of a heating medium;

FIGS. 4a to 4d are respective front elevational views of an eccentric shaft with turnable piston carriers supported on respective eccentric portions thereof, in the implementation from the centrally supported, all the way to the laterally supported, entraining carriers of the pistons in instantaneous configurations;

FIG. 4e is a partially cross-sectioned view of the arrangement of FIG. 4a;

FIG. 5 is an axonometric view of one of the dual piston carriers and its supports at the lateral ends of the eccentric shaft;

FIG. 6 is an axonometric view showing the rotary part of the machine with an indicated arrangement of various segments thereof;

FIG. 7 is an axonometric exploded view of the arrangement of the stator housing, with front and rear lids removed and also showing a supported rotary part of the machine;

FIG. 8 is a quasi-planar simplified diagrammatic developed view of the outer surface of the rotary part of the machine and the individual arrangements and interconnections of the cooperating cylinders;

FIG. 8a is a representation of the surface of FIG. 8 in cross section with indicated corresponding heat regenerators and a mutual connection of a cylinder of the cold corridor and a cylinder of the hot corridor; and

FIGS. 9a to 9d are substantially simplified diagrammatic end views of the rotary part of the machine illustrating the conditions prevailing within two cooperating cylinder and piston arrangements in the respective hot and cold corridors offset from one another by 90°.

### DETAILED DESCRIPTION OF THE PREFERRED EMBODIMENT

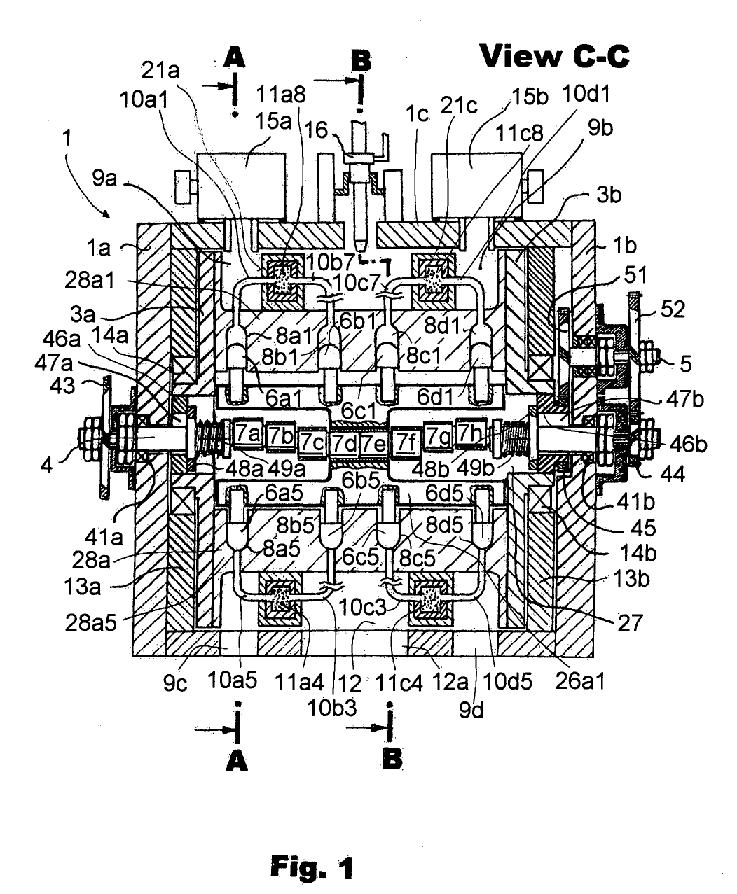

Referring now to the drawing in detail, and first to FIG. 1 thereof, it may be seen that the reference numeral 1 has been used therein to identify a stator housing of the machine embodying the present invention. A rotor including a multitude of parts to be discussed in detail below is accommodated in the interior of the stator housing 1. The stator housing 1 consists, in general, of two load-bearing end walls 1a and 1b that are spaced from one another in an axial direction of the machine, and a circumferential wall identified in its entirety by the reference numeral 1c and extending between and rigidly connected with the end walls 1a and 1b.

An eccentric shaft 4 is supported in the end walls 1a and 1b by respective bearings 41a and 41b. The eccentric shaft 4 is shown to pass through a respective passage in each of the end walls 1a and 1b. The eccentric shaft 4 also passes at its axial end close to the end wall 1a through an opening 47a provided in a first entraining ring 46a and, similarly, at its end closer to the end wall 1b through an opening 47b provided in a second entraining ring 46b. An external secondary output torque gear wheel 43 is supported on that end portion of the eccentric shaft 4 that passes to the outside of the housing 1 through the first load-bearing wall 1a, and a main hypocycloidal system is situated at the opposite axial end of the eccentric shaft 4. This hypocycloidal system includes, at the exterior of the stator housing 1, an external eccentric shaft gear wheel 44 that meshes with an external auxiliary shaft gear wheel 52 that is supported on an auxiliary shaft 5. The auxiliary shaft 5 passes through the end wall 1b from the exterior back into the interior of the stator housing 1. An internal auxiliary shaft gear wheel 51 is supported on the opposite inner end of the auxiliary shaft 5 and meshes with a gear pinion 45 that is rigidly connected with the second entraining ring 46b of the rotary part of the machine. The transmission ratios of the gears 44, 52, 51 and 45 are chosen in such a manner that the overall transmission ratio, that is the ratio of the rotational speeds of the second entraining ring 46b and the eccentric shaft 4, is 1:2. So, for instance, as may be perceived from FIG. 1 of the drawing, the transmission ratio of the gears 44 and 52 may be 1:2 so that the auxiliary shaft 5 turns at half the angular speed of the eccentric shaft 4; then, the transmission of the gears 51 and 45 will be 1:1.

As alluded to before, the rotor contains a great number of parts; however, many of these parts are structural and functional equivalents of one another, so that they have been grouped in respective families of reference numerals, each family starting with a different generic number followed by a letter indicative of the axial position of the part, and then a number indicating its circumferential position. For simplification, the generic family number, or the generic family number followed by the axial position letter, will be used occasionally, as appropriate, for any member of the family if no differentiation between them is necessary. Thus, reference may be had to pistons 6, or 6a, cylinders 8 or 8a, conduits 10 or 10a, regenerators 11 or 11a, piston carriers 26a, cylinder carriers 28a etc. Of course, if need be, members of these families will be mentioned specifically, but it is to be understood that a description of the structure and/or arrangement and/or function of any such family member is equivalently applicable to any other member of such family.

Thus, starting with the specific, a dual piston carrier 26a1 is interposed between the first entraining ring 46a and the second entraining ring 46b, being supported on a central pair of eccentrics 7d and 7e of the eccentric shaft 4. In the situation illustrated, for instance, in FIG. 1 of the drawing, the dual piston carrier 26a1 assumes a vertical orientation. The dual piston carrier 26a1 supports a pair of oppositely arranged pistons 6a1 and 6a5 that are associated with a first cold corridor 9a of the machine. The first cold corridor pistons 6a1 and 6a5 are received in corresponding first cold corridor cylinders 8a1 and 8a5 that are associated with the first cold corridor 9a as well and that are formed in respective oppositely arranged segments 28a1 and 28a5 of a cylinder carrier 28a interposed between and rigidly connected with axially spaced first and second end members 3a and 3b that respectively adjoin a first and a second stationary internal wall 13a and 13b of the stator housing 1 at a spacing therefrom while also embracing the first entraining ring 46a and the second entraining ring 46b, respectively.

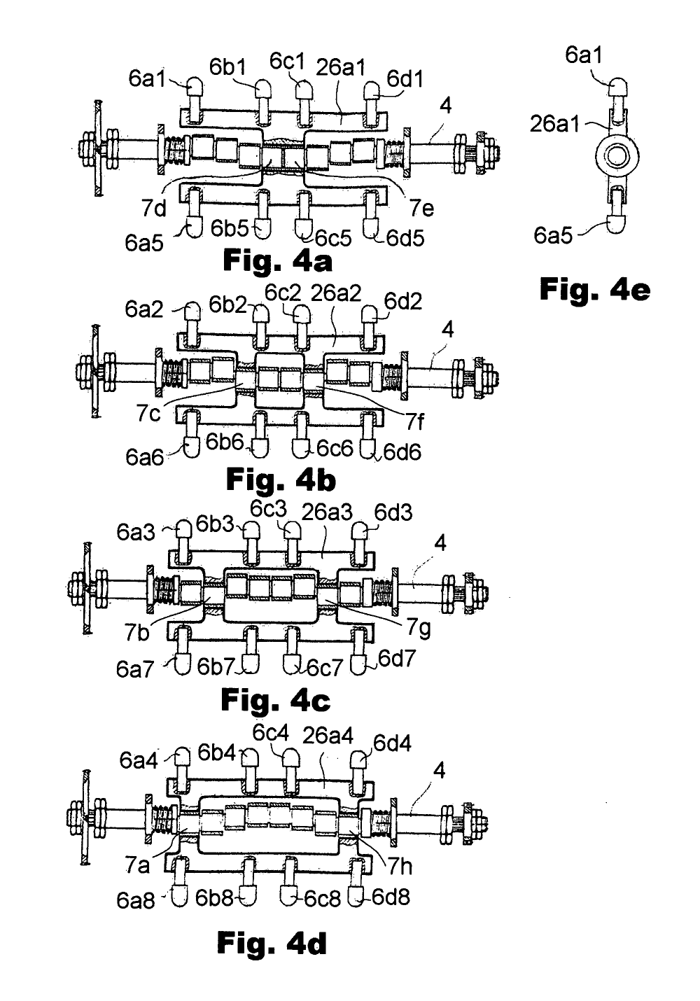

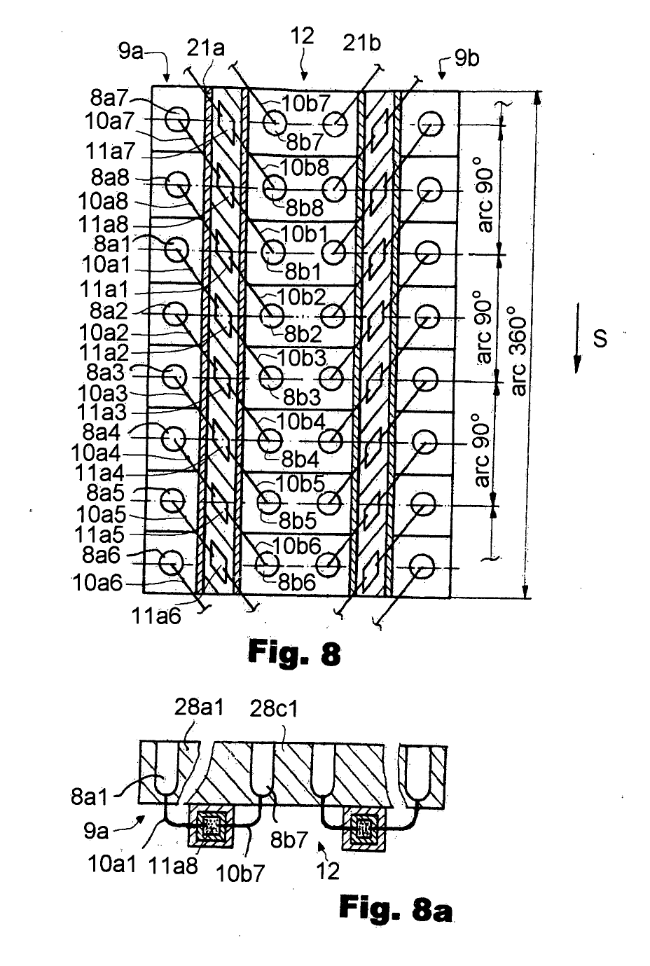

Each of the cylinders 8a1 and 8a5 of the first cold corridor cylinder pair is connected, via a respective connecting conduit 11a1 or 10a5, through an associated heat regenerator 11a8 or 11a4 and via another respective connecting conduit 10b7 or 10b3, with a cooperating cylinder 8b situated in a hot corridor 12 of the machine. As depicted particularly in the developed view of FIG. 8, these cooperating cylinders 8b of the hot corridor 12 are 8b7 and 8b3, respectively. More particularly, the cylinder 8a1 of the first cold corridor 9a of the machine is connected with a cooperating cylinder 8b7 of the hot corridor 12 of the machine that receives a piston 6b7 that is supported on that dual piston carrier 26a (as will become apparent later, 26a3) which is angularly displaced by 90° with respect to the double piston carrier 26a1 as considered in a direction S of rotation of the rotor. Correspondingly, the cylinder 8a5 of the first cold corridor 9a of the machine is connected with a cooperating cylinder 8b3 of the hot corridor 12 of the machine that receives a piston 6b3 that is supported on the very same angularly displaced dual piston carrier 26a (i.e. 26a3 in this instance). These two piston carriers 26a1 and 26a3 are shown in some detail in FIGS. 4a and 4c of the drawing, respectively.

The first entraining ring 46a and the second entraining ring 46b are supported on the oppositely situated internal walls 13a and 13b of the stator housing 1 by means of respective rotor bearings 14a and 14b via the interposed cylinder carrier 28a.

The eccentric shaft 4 is provided at its end portions situated in the interior of the stator housing 1 with a sealing system for a space 27 for accommodating a working storage medium, wherein the sealing system is constituted by a friction ring 48a or 48b and a compression spring 49a or 49b, respectively. The springs 49a and 49b are shown to be configured as helical springs.

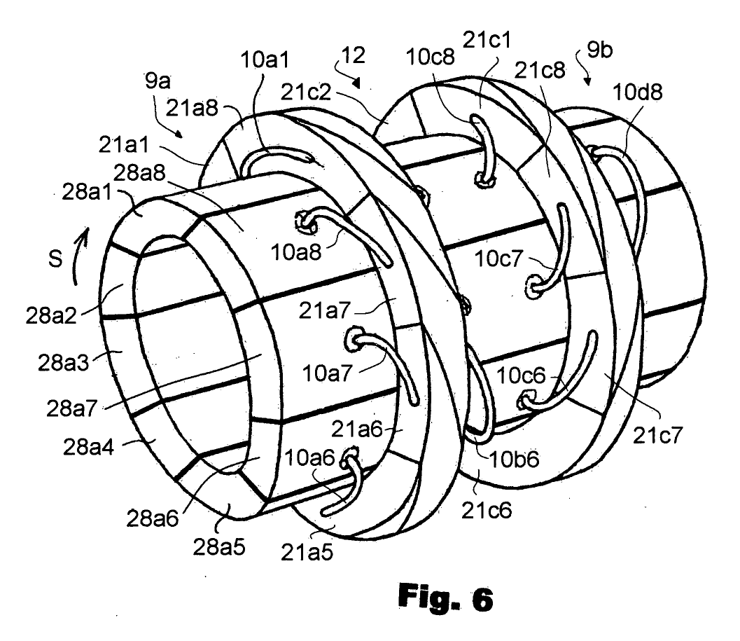

The heat regenerators 11 are to advantage integrated in sheaths supported in regenerator casings 21 associated in each instance to one of segments of the pair of segments of the cylinder carrier 28a, such as 28a1 and 28a5. These regenerator casings 21a (that is, casings 21a1 to 21a8) complement one another circumferentially in a manner evident from FIG. 6 of the drawing collectively to constitute a radial thermal separating wall between the first cold corridor 9a of the machine and the hot corridor 12. The same is also symmetrically done in the depicted implementation of the present invention at the opposite axial end of the rotor to thermally separate the hot corridor 12 by a series of casings 21b (that is, casings 21b1 to 21b8) from a second cold corridor 9b It should be appreciated that, as illustrated, the rotor of the machine is, by and large, axially symmetrical so that any discussion of families of parts 6, 8, 10 and 11 with suffixes a and b is equivalently applicable to their counterparts with suffixes d and c, respectively. By the same token, the eccentrics 7a to 7d have their respective counterparts in eccentrics 7h to 7e, in respective pairs 7a and 7h, 7b and 7g, 7c, and 7f and 7d and 7e, the eccentrics of each of these pairs having the same distance from the middle of the rotor.

An outlet of a first independent source 15a of a cooling medium, constituted in the specific case, for instance, by a blower, is connected to the first cold corridor 9a of the machine, and an outlet of an independent source 16 of an energizing medium, constituted in a given case, for instance, by a burner, is connected to the hot corridor 12 of the machine. Also, an outlet of another source 15b of a cooling medium, similar to if not identical with the source 15a, is connected to the second cold corridor 9b.

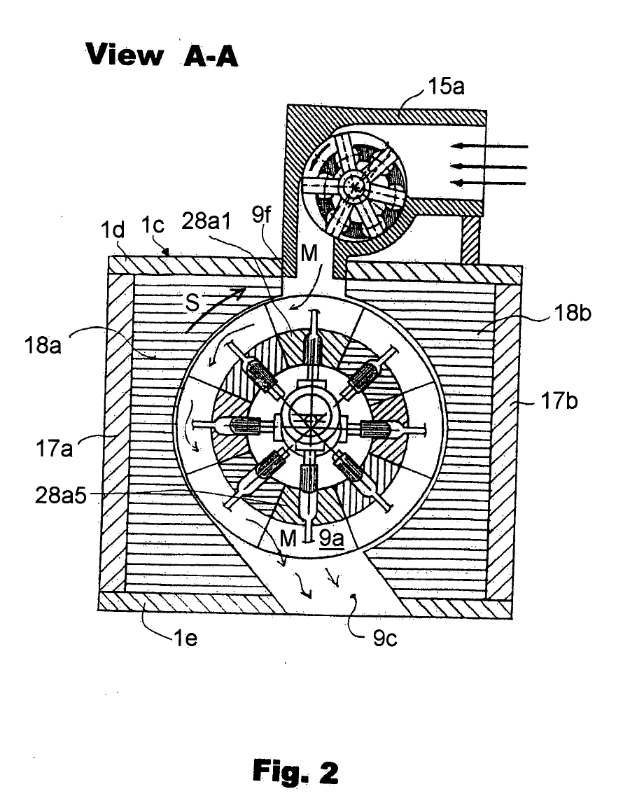

FIG. 2 illustrates, in a cross section A-A, a view of the first independent source 15a of a cooling medium and its outlet into the first cold corridor 9a of the machine and an outlet channel 9c for discharging the spent cooling medium from the first cold corridor 9a of the machine. Simultaneously, there is visible therein a thermally insulating front-end lid insert 18b that is secured to a front-end lid 17b of the stator housing 1, and a thermally insulating rear-end lid insert 18a that is secured to a rear-end lid 17a of the stator housing 1, as well as top and bottom walls 1d and 1e that complete the circumferential wall 1c of the stator housing 1. An arrow S indicates, like it does in all other Figures in which it appears, the direction of rotation of the rotor, while arrows M indicate the flow of the cooling medium through the first cold zone 9a from the source 15a to the outlet 9c.

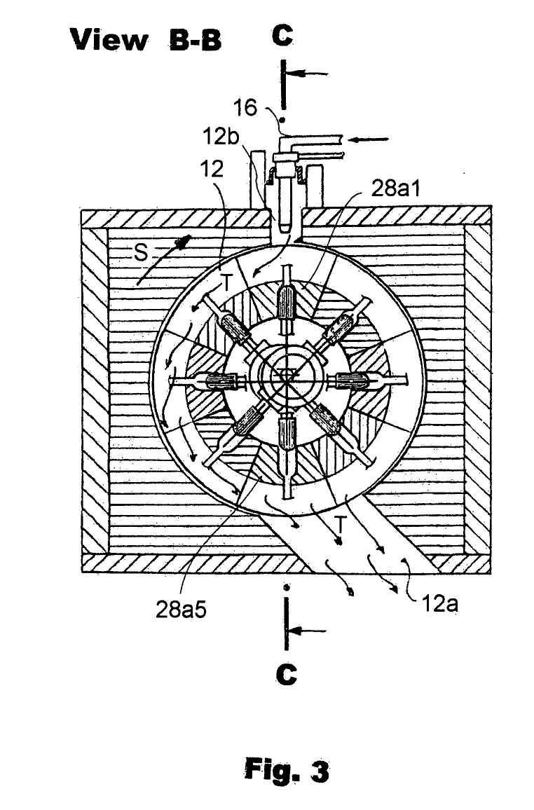

FIG. 3 shows a view of the independent source 16 of an energizing medium and, in a cross section B-B, its outlet into the hot corridor 12 of the machine, and an outlet channel 12a of the hot corridor 12. Arrows T indicate the direction of flow of the hot medium introduced by the energizing medium source 16 into the hot corridor 12 all the way to and through the outlet channel 12a.

FIGS. 4a to 4d depict, in partial longitudinal sections, the support of the individual piston carriers 26a on the eccentric shaft 4, with a different one of such piston carriers 26a being situated in a vertical position in each of these Figures. More particularly, FIG. 4a illustrates an implementation of the double piston carrier 26a1 with a support on the central eccentrics 7d and 7e of the eccentric shaft 4, FIG. 4b illustrates support of a double piston carrier 26a2 on an adjoining pair of eccentrics 7c and 7f of the eccentric shaft 4, FIG. 4c illustrates support of a double piston carrier 26a3 on further adjacent eccentrics 7b and 7g of the eccentric shaft 4, and FIG. 4d illustrates support of a double piston carrier 26a4 on end eccentrics 7a and 7h of the eccentric shaft 4. Additionally, FIG. 4d represents, in a cross section, the double piston carrier 26a1 and the support of a pair of pistons 6a1 and 6a5 on piston rods secured to the double piston carrier 26a1.

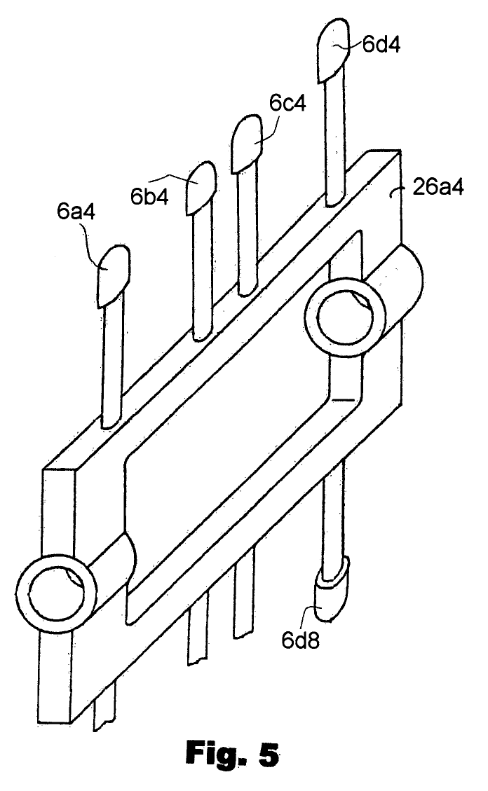

FIG. 5 represents, in an axonometric view, an example of a support of respective pairs of pistons, such as 6d4 and 6d8, on piston rods that are firmly inserted into the double piston carrier 26a4. The other remaining pistons 6 are supported on the associated double piston carriers 26a in respective pairs in the same manner as well.

FIG. 6 represents, in an axonometric view, the rotary part of the machine, in which the arrangement of the individual segments 28a1 to 28a8 is visible, together with the radial arrangement of the corresponding regenerator casings 21a and 21c. The respective connecting channels 10 emerge from the associated ones of the casings 21a and 21c to interconnect the respective cylinders 8a or 8d of the cold corridors 9a and 9b with their respective associated cylinders 8b or 8c of the hot corridor 12 through the associated heat regenerators 11 in the associated segment. The arrangement is such, as will be more thoroughly explained later, that the respective cylinder 8a or 8d of the cold corridor 9a or 9d is in each instance connected with a cylinder 8b or 8c of the hot corridor 12 that is angularly displaced by 90° relative thereto opposite to the direction of rotation S. It may also be perceived from FIG. 6 that the casings 21a of the regenerators 11 that are circumferentially arranged on the segments 28a complement one another circumferentially to constitute the thermally separating wall or shield over the entire circumference of the rotor and, symmetrically and correspondingly, this is true about the casings 21c arranged at the opposite axial end of the rotary part of the machine as well.

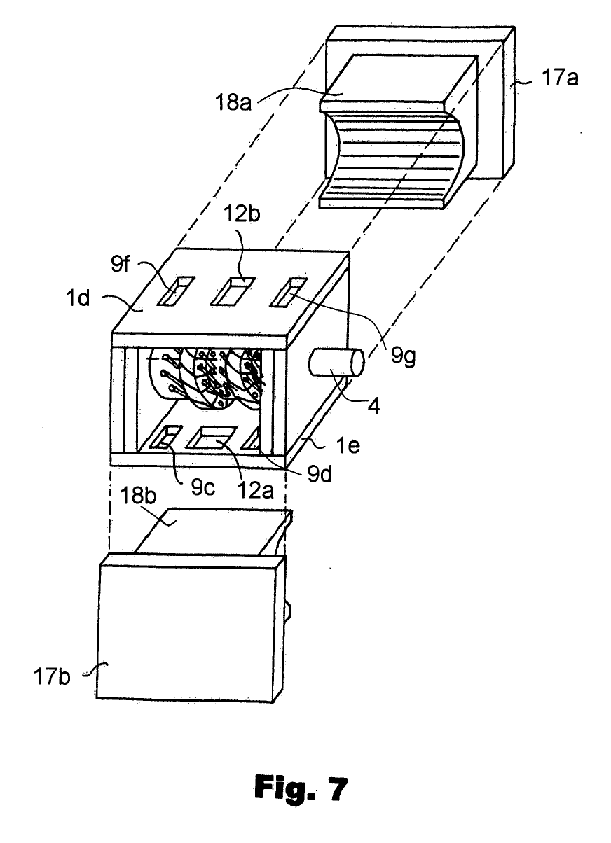

FIG. 7 shows an implementation of the stator part 1 of the machine with both the front-end lid 17b and the rear-end lid 17a removed, where the thermally insulating insert 18b of the front-end lid 17b and the thermally insulating insert 18a of the rear-end lid 17a may be observed as well. Simultaneously, inlets 9f and 6g of the cooling medium from the first and second independent sources 15a and 15b of the cooling medium—not illustrated here—and an inlet 12b of the energizing medium from the independent source 16 of the energizing medium—not illustrated here either—are shown in the upper wall or lid id of the stator housing 1. The outlet channel 9c of the first cold corridor 9a, the outlet channel 12a of the hot corridor 12, and an outlet channel 9d of the second cold corridor 9b are visible in the lower wall or lid 1e of the stator housing 1.

FIG. 8 is, as already mentioned before, a developed view of the rotary part of the machine, that is, a somewhat simplified top plan view of a developed outer surface thereof with sections through the casings 21a and 21c of the regenerators 11. The mutual connections of the individual cylinders 8a of the first cold corridor 9a with the associated cylinders 8b of the hot corridor 12 are apparent there. So, for instance, it may be observed that the cylinder 8b1 of the hot corridor 12 that is connected by a connecting conduits 10b1 and 10a7 with a cylinder 8a7 of the first cold corridor 9a is angularly advanced by 90 ° in the direction S of rotation of the rotary part of the machine with respect to the thus associated cylinder 8a7 of the first cold corridor 9a. It should go without saying that the cylinders 8a8 to 8a6 of the first cold corridor 9a are connected by the corresponding connecting channels 10a8 to 10a6 and 10b2 to 10b8 with the respective associated cylinders 8b2 to 8b8 of the hot corridor 12 such that, in each instance, consistently, the corresponding cylinders 8b of the hot corridor 12 are angularly advanced by 90° the direction of rotation S of the rotary part of the machine with respect to the corresponding cylinders 8a of the cold corridor 9a. The same is applicable at the other axial end of the rotary part of the machine with respect to the cylinders 8c and 8d and conduits 10c and 10d, so that it is not necessary to expound on this here and, consequently, the corresponding reference numerals have even been omitted from FIG. 8 so as not to unnecessarily clutter the same.

FIG. 8a represents, in cross section, the connection of the cylinder 10a1 of the cold corridor 9a formed in the segment 28a1 through the connecting conduits 10a1 and 10c7, with the regenerator 11b8 interposed between them, with the cylinder 8b7 of the hot corridor 12 formed in the corresponding segment 28c1 that is angularly displaced by 90° in the direction S of rotation of the rotary part of the machine, as will become apparent from a comparison with FIG. 8 of the drawing.

The function of the rotary thermal machine according to the invention is based on the principle of the Stirling thermodynamic cycle with closed circulation, where the movable pistons 6 operate in respective shared and closed working spaces each constituted by the associated cylinder 8b or 8c of the hot corridor 12, the connecting conduit 10a and 10b or 10d and 10c, the heat regenerator 11a or 11b, and the cylinder 8a or 8d of the cold corridor 9a or 9b. The cylinder 8a or 8d of the cold corridor 9a or 9b is being cooled by the cooling medium flowing in the first cold corridor 9a or 9b over its outer surface and a part of the connecting conduit 10a or 10d passing through the cold corridor 9a or 9b. The cylinder 8b or 8c of the hot corridor 12 is being heated via its outer surface and a part of the connecting conduit 10b or 10c passing through the hot corridor 12. The two cylinders 8a and 8b or 8d and 8c that are mutually connected by means of the connecting conduits 10a and 10b or 10d and 10c and the interposed heat regenerator 11a or 11b are filled by a gas serving as a working medium. Initially, expansion of this working medium, for instance helium or air, is encountered in the cylinder 8b or 8c of the hot corridor 12 owing to the heat being supplied, and it presses the piston 6b or 6c accommodated in this cylinder 8b or 8c in the radially inward direction. Mechanical work is performed in the course of this phase of operation. During its subsequent return travel, the piston 6b or 6c pushes the previously expanded gas out of the cylinder 8b or 8c of the hot corridor 12 into the cylinder 8a or 8d of the cold corridor 9a or 9b, so that the still hot gas flowing through the channel 10b or 10c transfers heat in the interposed cold heat regenerator 11a or 11b and cools down in the process. The piston 6a or 6d in the cylinder 8a or 8d of the cold corridor 9a or 9b lags by at least approximately one-fourth of revolution behind the piston 6c or 6d of the hot corridor 12, as a result of which it creates space in the cylinder 8a or 8d of the cold corridor 9a or 9b for the already expanded and partly cooled gas expelled from the cylinder 8b or 8c of the hot corridor 12. Moreover, this gas is being cooled further as it flows through the cold corridor 9a or 9b through respective conduit 10a or 10d. After that, the working gas is compressed again during the return movement of the piston 8a or 8d of the cold corridor 9a or 9b to a relatively small volume and is transferred to the cylinder 8b or 8c of the hot corridor 12. The gas being transferred in its compressed state from the cylinder 8a or 8d of the cold corridor 9a or 9b into the cylinder 8b or 8c of the hot corridor 12 accepts in the heat regenerator 11a or 11b the heat that had been previously deposited in that regenerator 11a or 11b during the passage of the expanded gas from the cylinder 8b or 8c of the hot corridor 12 into the cylinder 8a or 8d of the cold corridor 9a or 9b. The gas leaving the respective regenerator 11a or 11b is further heated as it flows through the hot corridor 12 in the respective conduit 10b or 10c. In total, the work performed during the expansion in the cylinder 8b or 8c of the hot corridor 12 is greater than the work required for the transfer of the gas. An acquired proportion of work remains after the elapse of one cycle from this difference between the retrieved and consumed work, constituting a real proportion of acquired mechanical energy that is available for use at the external output gear wheel 43.

The space 27 contains a pressurized supply of the working gas that has been introduced into the space 27 from an independent pressure source of the working medium before putting the machine into operation. This space 27 thus serves as a reservoir of the pressurized working gas to prevent or at least minimize leakage of the working gas from the cylinders 8 past the pistons 6 and/or to replenish any leaked gas amounts.

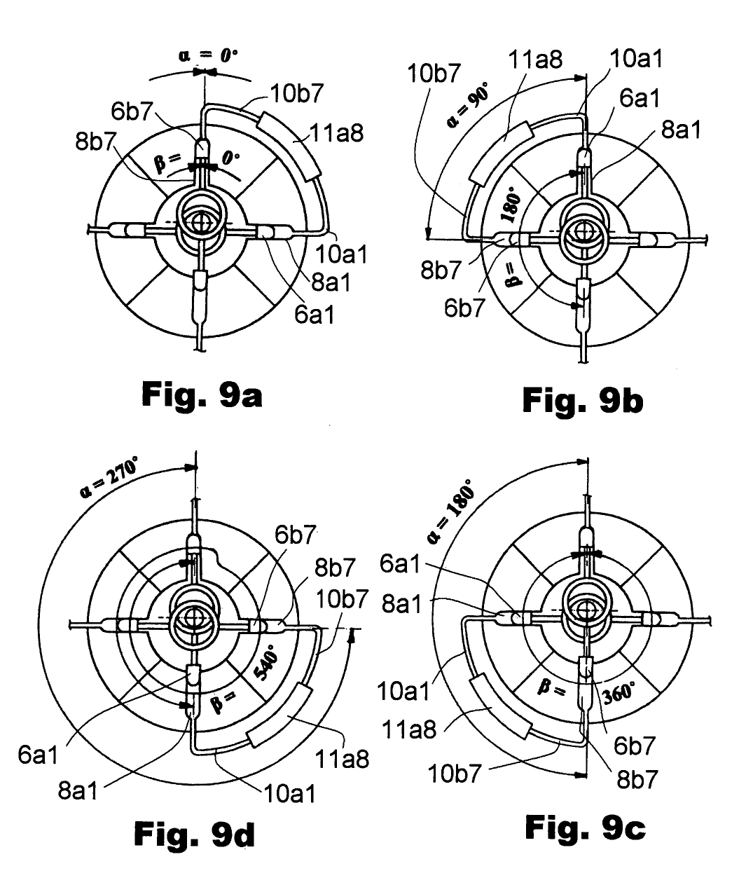

Now that the operation of the machine of the present invention has been described in general terms, it will be explained in more detail on the basis of FIGS. 9a to 9d with reference to only one pair of cooperating pistons 6a1 and 6b7 carried on a piston carrier 26a, and the cylinders 8a1 and 8b7 provided in the cylinder carriers 28a1 and 28a3, and conduits 10a1 and 10b7 and the regenerator 11b8 interposed between them, respectively. It will be appreciated that, even though the various parts are shown to be located in the plane of the drawing, and in axial views, they are actually located along planes indicated as A-A and B-B in FIG. 1 and thus would potentially obscure one another if FIGS. 9a to 9d were other then merely schematic and/or partly cross-sectioned without indicating the cross sections.

The four FIGS. 9a to 9d show the positions of the various cooperating parts in the course of a single revolution of the rotor (as indicated by the angle a) and two revolutions of the eccentrics 7e and 7h sharing in the rotation of the eccentric shaft that rotates in the same direction as the rotor but at twice the angular velocity thereof (as indicated by the angle β). These positions are representative of the various phases of operation of the machine, as will now be discussed. It should go without saying that the operation is cyclical, that is, that, after going through the positions shown in FIGS. 9a to 9d, the rotor continues its rotation until it reaches the position of FIG. 9a again, after which the whole process is repeated.

In FIG. 9a, the piston 6b7 is in its outermost position in the associated hot corridor cylinder 8b7 situated in the cylinder carrier segment 28a7, that is, in a position immediately preceding the expansion of the hot compressed gas in the cylinder 8b7. Of course, the eccentric 7f, and with it the dual piston carrier 26a1, are in their uppermost positions as well. (i. e. α=0°, β=0°). At the same time, the eccentric 7d, and with it the piston carrier 26a3, are in their central positions, so that the space made available in the cold corridor cylinder 8a1 by the assumption of the corresponding intermediate position by the piston 6a1 accommodates some of the enclosed gas volume with attendant cooling thereof. Now, as the compressed hot gas in the cylinder 8a7 expands, it pushes the piston 6a7 out of the cylinder 8a7 with resulting exertion of a force on the eccentric 7f and commencement of a movement of the rotor toward the position shown in FIG. 9b. As this happens, the eccentric 7d displaces the cold corridor piston 6a1 in the outward direction, thus compressing the gas present in the cold corridor cylinder 8a1 and expelling it through the conduit 10a1 into the regenerator 11a1 where it displaces some of the gas present therein that, in case there was already a preceding operation of the machine, has accepted some of the heat contents previously deposited in the regenerator 11a1, expelling it through the conduit 10b7, where it is further heated, into the hot corridor cylinder 8b7 the volume of which is increasing during this phase of operation as the piston 6b7 recedes into the cylinder 8b7.

In the position of FIG. 9b, (i.e. α=90°, β=180°, the effective volume of the cold corridor cylinder 8a1 is basically zero, and the gas previously expelled therefrom has traveled into the regenerator 11a1 while some of the gas previously present in the regenerator 11a1 and heated in the hot corridor conduit 10b7 if not previously in the regenerator 11a1 enters the hot corridor cylinder 8a1 where it further expands to contribute to the downward displacement of the hot corridor piston 6a7.

In the position of FIG. 9b, the cold corridor piston 6a1, after reaching its uppermost position, reverses its course of movement, thus making more and more space available in the cold corridor cylinder 8a1 for the accommodation of the working gas. However, the free volume in the hot corridor cylinder 8b7 is still on the rise at this time, but the reduced density of the working gas that is attributable to its heating in the hot corridor cylinder 8b7 and the increased density of the working gas as it is being cooled in the cold corridor take care of this situation. Eventually, the rotor reaches it position depicted in FIG. 9c (i.e. α=180°, β=360°) in which the hot corridor piston 6b7 has reached it innermost position while the cold corridor piston 6a1 has retreated into its intermediate position. From this moment on, the hot corridor piston 6b7 is forced by the action of the remaining pistons 6 on the eccentric shaft 4 to move toward its position shown in FIG. 9d (i. e. α=270°, β=540° and eventually back into the position shown in FIG. 9a. As this progresses, the spent working gas in the hot corridor cylinder 8b7 is expelled by the action of the piston 6a7 thereon out of the cylinder 8b7 and through the hot corridor conduit 10b7 into the regenerator 11b1 where it leaves some of its heat contents for use during the next following cycle, as mentioned above. At the same time, this hot corridor working gas displaces some of the working gas present at that time in the regenerator 11a1 through the cold corridor conduit 10a1 into the space made available in the cold corridor cylinder 8a1 by the retreating piston 6a1.

The thermodynamic and working medium flow conditions are such that the amount of mechanical energy applied by the hot gas in the hot corridor 12 over the course of each rotation of the rotor exceeds that expended on the movement of the pistons 6 and the associated movable parts of the rotor back into their initial positions, inasmuch as the machine operates in the same manner as other machines utilizing the Stirling thermodynamic cycle without, however, needing the numerous and complicated parts required by such known machines.

Without further analysis, the foregoing will so fully reveal the gist of the present invention that others will be able, by applying only ordinary skill in the art, readily use the teachings of the present application for various applications.

While the present invention has been described as being embodied in a machine for converting heat energy into mechanical energy, it is not limited to the details show because various modifications thereof could be readily made without exceeding the scope of the present invention. So, for instance, the machine of the present invention could be used, after only slight modifications, such as the removal of the heating and cooling sources, as a heat pump that would convert mechanical energy supplied to the eccentric shaft into thermal energy, i. e. for heating the gas in the hot corridor and/or cooling the gas in the cold corridor, depending on the environmental temperature at the place of use of the machine. Also, while the machine has been disclosed as having two cold corridors flanking a single hot corridor, the number of such corridors could be larger or smaller, so long as there alternation between the hot and cold corridors would be assured.

What is considered to be new and desired to be protected by the Letter Patent will appear from the following claims.

1. A rotary thermal machine operating on the principle of the Stirling thermodynamic cycle, comprising
a stator housing surrounding an internal space;
an eccentric shaft mounted on said stator housing for rotation about a main axis extending across said internal space of said stator housing and including a plurality of circumferentially equidistantly spaced eccentric portions centered on respective eccentric axes parallel with said main axis;
a plurality of substantially radially extending double piston carriers each mounted on at least one said eccentric portions of said eccentric shaft for movement with the respective eccentric portion about said main axis but with freedom of angular movement about said eccentric axis;
a predetermined number of pistons immovably supported on said double piston carriers and extending substantially radially outwardly therefrom in opposite directions;
a rotor mounted in said internal space for rotation in a predetermined direction about said main axis in including at least one cylinder carrier having said predetermined number of cylinders therein, each for accommodating one of said pistons;
means for defining at least one cold corridor and at least one hot corridor around said rotor, some of said cylinders being associated with said cold corridor and the remaining ones being associated with said hot corridor, said defining means including at least one thermal separator wall separating said at least one cold corridor from said at least one hot corridor;
individual conduit means each connecting one of said cylinders associated with said cold corridor through said thermal separator wall with a corresponding one of said cylinders associated with said hot corridor that is spaced ahead thereof by an angular distance of 90° as considered in the direction of rotation of said rotor; and
a transmission interposed between said eccentric shaft and said rotor and having an overall transmission ratio of 1:2 so that said eccentric shaft rotates at twice said predetermined speed of rotation of said rotor at all times.

2. The rotary thermal machine as defined in claim 1, wherein each of said individual conduit means includes a heat regenerator, and hot and cold corridor conduits connecting said heat regenerator with said hot and cold corridor cylinders, respectively.

3. The rotary thermal machine as defined in claim 2, wherein each of said regenerators is situated within said at least one thermal separator wall.

4. The rotary thermal machine as defined in claim 3, wherein said at least one thermal separator wall includes a plurality of individual segments each including one of said regenerators and all complementing each other in the circumferential direction of said rotor into said separator wall.

5. The rotary thermal machine as defined in claim 1, wherein said eccentric shaft has at least one end portion extending to the exterior of said stator housing; and further comprising an output torque gear mounted on said one end portion of said eccentric shaft for joint rotation therewith

6. The rotary thermal machine as defined in claim 1, wherein said transmission includes an auxiliary shaft mounted on said housing for rotation about an auxiliary axis parallel to and spaced from said main axis; a first pair of meshing gears mounted on corresponding portions of said eccentric and auxiliary shafts, and a second pair of meshing gears one connected with said auxiliary shaft and the other with said rotor for joint rotation therewith.

7. The rotary thermal machine as defined in claim 6, wherein said first pair of meshing gears has a transmission ratio of 1:2 and said second pair of meshing gears that of 1:1.

8. The rotary thermal machine as defined in claim 1, wherein said rotor includes a plurality of segments each containing at least one of said cylinders associated with said cold corridor and one of said cylinders associated with said hot corridor.

9. The rotary thermal machine as defined in claim 1, wherein said double piston carrier with said pistons mounted thereon, said eccentric portions of said eccentric shaft carrying the respective double piston carrier, respective portions of said rotor containing said cylinders, and said conduit means, together form a unit; and further comprising a predetermined number of additional such units similar to said unit and equidistantly angularly displaced about said main axis relative thereto and to one another.

10. The rotary thermal machine as defined in claim 1; and further comprising a sealing system at each end of said eccentric shaft, including a friction ring and a pressure spring acting thereon.

11. The rotary machine as defined in claim 1, wherein said stator housing has respective inlets and outlets communicating with said hot and cold corridors, respectively; and further comprising at least one source of a cooling fluid for introducing the cooling fluid through a respective one of said inlets into said cold corridor for flow therethrough to an associated one of said outlets, and at least one source of a heating fluid for introducing the heating fluid through another one of said inlets into said cold corridor for flow therethrough to a different associated one of said outlets.

12. The rotary machine as defined in claim 11, wherein said respective inlet, said at least one cooling fluid source, said cold corridor itself, and said associated outlet from said cold corridor are arranged and configured in such a manner that said cooling fluid flows through said cold corridor in a direction opposite to said direction of rotation of said rotor.

13. The rotary machine as defined in claim 11, wherein said other inlet, said at least one heating fluid source, said hot corridor itself, and said different associated outlet from said hot corridor are arranged and configured in such a manner that said heating fluid flows through said hot corridor in a direction opposite to said direction of rotation of said rotor.
